(19) United States
(12) Patent Application Publication
(10) Pub. No.: US 2011/0000092 A1
(43) Pub. Date: Jan. 6, 2011

(54) Cutter for laminate flooring and the like

(76) Inventors: Matt A. Boyce, Jonesnboro, GA (US); Eric J. Fenzl, Loganville, GA (US)

Correspondence Address: Star Packaging Corporation;Attn: Eric Fenzl, 453 85 Circle, College Park, GA, 30349, US

(21) Appl. No.: 12/803,722

(22) Filed: Jul. 2, 2010

Related U.S. Application Data
(60) Provisional application No. 61/270,113, filed on Jul. 2, 2009.

(51) Int. Cl. B27G 17/00; E04F 21/20; B27D 5/00

(52) U.S. Cl. 30/280; 52/749.1; 30/283

(57) ABSTRACT

A cutting tool for laminate flooring and the like for removing some or all of the retaining lip on a flooring plank to facilitate sliding the plank into place under an obstruction such as a door frame. The cutting tool comprises a main housing with a recess to allow it to be positioned against a flooring plank. An adjustment screw allows the cutting blade to adjust vertically to remove material from varying sizes of planks. An alternate embodiment of the cutting tool positions the cutting edge of the razor blade at the same vertical position as the retaining lip of the flooring plank to remove all of the retaining lip.

### CROSS REFERENCE TO RELATED APPLICATIONS

This application claims the benefit of provisional patent application Ser. No. 61/270,113, filed 2009 Jul. 2 by the present inventor.

### FEDERALLY SPONSORED RESEARCH

None

### BACKGROUND

1. Field

This invention relates to cutters used in the flooring industry, specifically those used at a job site to modify the edge of interlocking flooring members. Hardwood and laminate flooring is becoming increasingly popular in both the residential and commercial flooring industry. Hardwood and laminate flooring is an attractive option over vinyl flooring and it tends to increase the value of a home or office space.

Improvements have been made in laminate flooring in particular to create an easy to use system for installation. The main improvements relate to how each plank of flooring joins with the preceding plank. U.S. Pat. No. 7,386,963 to Pervan (2008) illustrates one such locking system. Pervan teaches of a projecting portion of material in addition to a standard tongue and groove to keep the next flooring plank locked in place when pressed down against the subfloor. U.S. Pat. No. 6,591,568 to Paålsson (2003) teaches another system that uses a tongue, groove, and lip to ease installation. Installation involves laying a row of planks down, inserting the tongue of the next plank of flooring into a groove in the preceding plank at an angle, and rotating the new plank into place. When the new plank is laid into place, a lip on the preceding plank is accepted into a groove on the bottom of the new plank to lock them in place.

The tight fit between the locking members of the flooring planks keep them against one another and prevent the planks from sliding relative to one another. This advantageous locking mechanism also poses a problem when installing flooring around a doorway or other obstruction. To create the proper appearance of the new floor, the installer generally cuts the lower portion of the door jam, inserts and rotates a new plank to join it to the preceding plank, and slides the new plank under the door frame. Since the design of the joints locks the planks together, a pulling bar and a hammer are needed to force the new plank under the door frame.

To relieve the joint and precipitate sliding of the planks, the installer must sand or cut the locking lip from the first row of planks prior to installation. The cutting is currently handled using a utility knife and a very steady hand to keep from damaging the flooring or the operators hand with the knife. Once the locking lip is removed, installation is the same as previously described with the exception of a small bead of carpenters glue to fasten the joint together.

2. Prior Art

Several cutters have been made for cutting specific pieces of material but none remove the retaining edge of tongue and groove flooring planks. U.S. Pat. No. 3,644,993 (1972) to Chupp will remove a corner of a board. U.S. Pat. No. 4,095,341 (1978) to Crain is designed to trim lengths of carpet. These types of razor blade based cutters were designed with a different material and razor blade orientation in mind.

U.S. Pat. No. 5,127,161 (1992) to Ikeda uses a cutter blade to trim material and comprises a groove to contain the material. However, this invention will not cut varying sizes of laminate flooring due to the u-shaped configuration of the groove. In order to protect the user from accidental cuts, the blade is oriented perpendicular to the top surface of the material to be cut. This orientation would trim the width of a flooring plank but not the thickness of the material or more specifically, the height of the retaining lip of the plank.

### DRAWINGS

FIG. 1 is a view of rows of hardwood or laminate flooring being installed near a door frame.

FIG. 2 is a view of a flooring plank locked in place relative to the other rows of flooring and slid under the door frame.

FIG. 3 is a view of the flooring trimmer in accordance with one embodiment shown removing the retaining lip from a piece of hardwood or laminate flooring.

FIG. 4 is an exploded view of the flooring trimmer in accordance with one embodiment.

FIG. 5 is an assembled top view of the flooring trimmer in accordance with one embodiment.

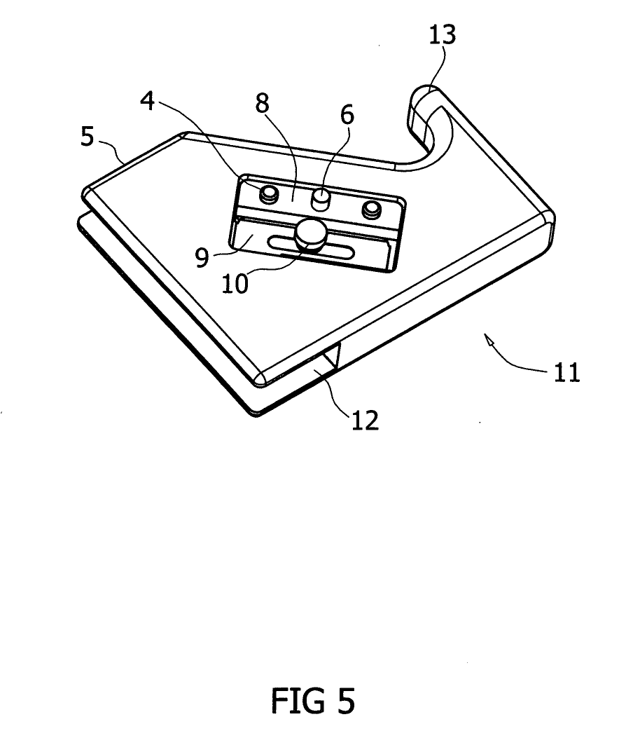

FIG. 6 is an assembled bottom view of the flooring trimmer in accordance with one embodiment.

FIG. 7 is a view of an alternate embodiment of the flooring trimmer showing a simplified method of construction.

FIG. 8 is an end view of the alternate embodiment of the flooring trimmer shown in FIG. 7.

DRAWINGS-Reference Numerals

| | | | |
|---|---|---|---|
| 1 | planks of flooring | 2 | new plank of flooring |
| 3 | door frame | 4 | dowel pin |
| 5 | main housing | 6 | adjusting screw |
| 7 | retaining ring | 8 | blade housing |
| 9 | razor blade | 10 | blade retaining screw |
| 11 | floor trimmer assembly | 12 | plank receptacle |
| 13 | handle | 14 | inspection hole |

### DETAILED DESCRIPTION

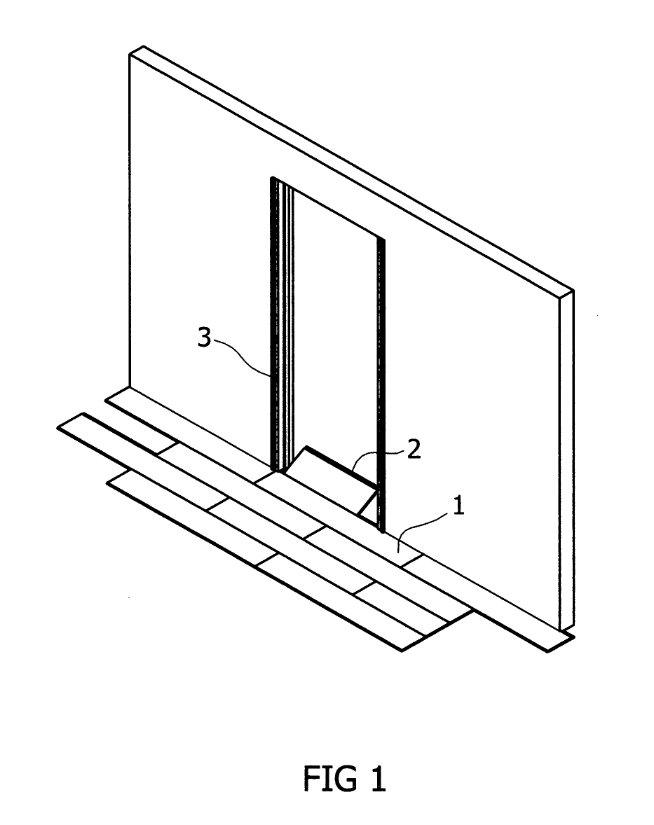

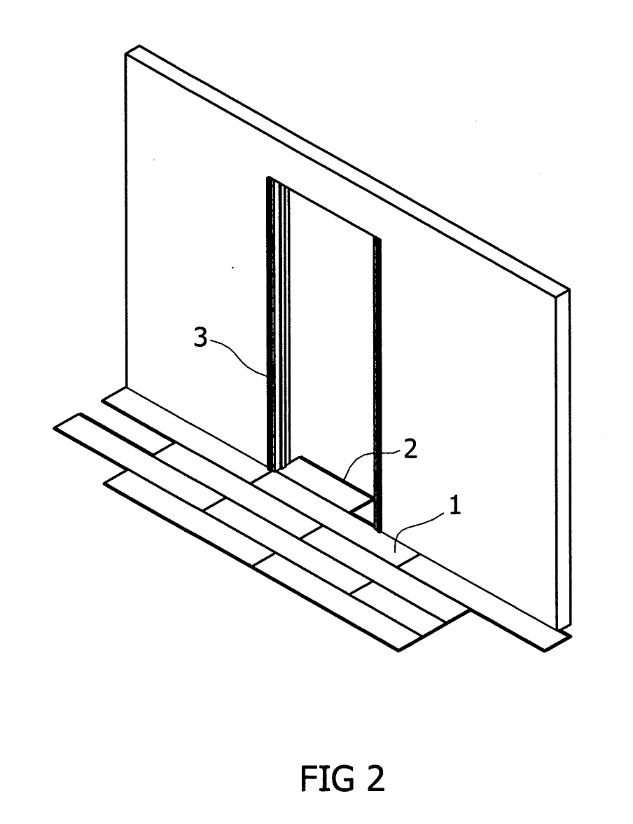

The process of installing hardwood or laminate flooring around a door opening is shown in FIG. 1. Planks of flooring (1) are laid down on the sub floor or underlayment. The new plank of flooring (2) positioned near the door frame (3) and the tongue of the new plank is inserted at an angle to the groove on the existing planks (1). Once the planks are in position against each other, the new plank of flooring (2) is rotated downward locking the two planks together as shown in FIG. 2. Since the fit of the two flooring planks is tight, a pry bar and hammer are required to tap the new flooring plank (2) under a cut in the door frame (3).

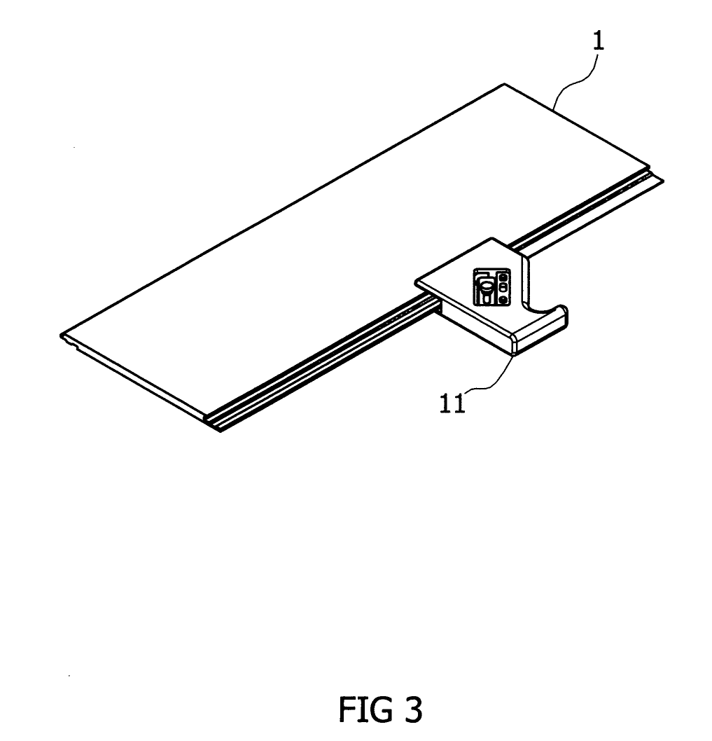

To facilitate the sliding of the two planks, flooring installers cut the retaining lip from the existing floor plank (1) prior to laying it down as shown in FIG. 3. Cutting of the lip is accomplished by holding the existing plank (1) on a table or the like and pulling the cutter assembly (11) along the edge of the plank (1). Once the retaining lip is trimmed from the existing plank (1), the plank (1) is repositioned in its respective row, and a small bead of wood glue is applied to the groove in the existing plank (1). With the retaining lip removed from the existing plank (1), the new plank (2) is inserted in the groove of the existing plank (1), rotated downward, and easily slid into place under the door frame (3).

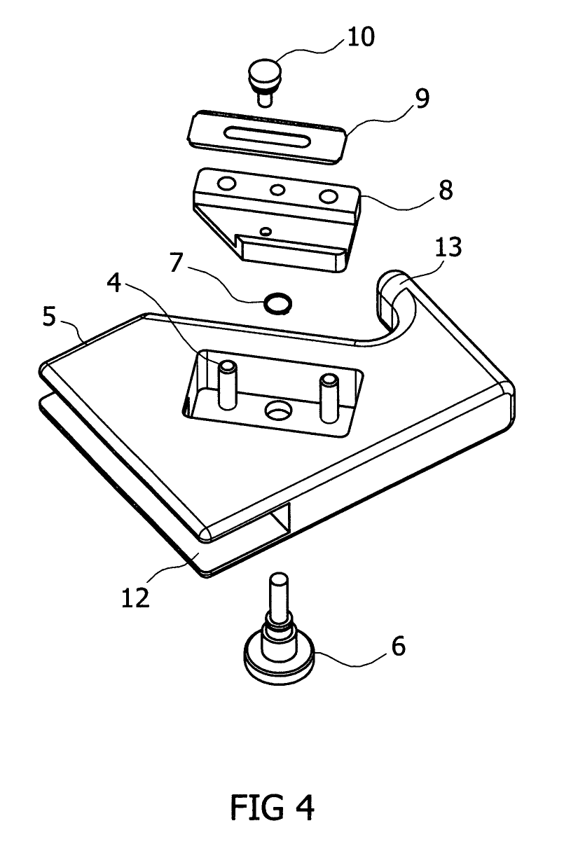

FIG. 4 shows an exploded view of one embodiment of the flooring trimmer. To assemble the trimmer (11), two dowel pins (4) are inserted in holes of the main housing (5). The dowels act as guides to prevent jamming of the blade housing (8) when the blade height is adjusted. The adjusting screw (6) is inserted in a hole in the back of the main housing (5) and held in place by a retaining ring (7). The blade guard (8) is positioned on top of the adjusting screw (6) and dowel pins (4). A tapped hole in the blade housing (8) allows the adjusting screw (6) to pull it toward the main housing (5) as the adjusting screw (6) is turned. A razor blade (9) is positioned in a pocket of the blade housing (8) and held in place with a blade retaining screw (10).

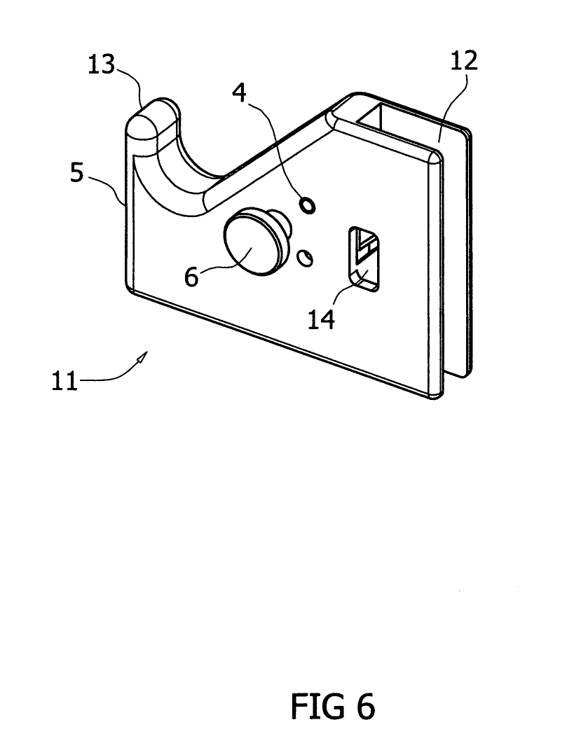

A plank receptacle (12) acts as a guide for the existing flooring plank (1) as shown in FIG. 6. The plank (1) is positioned on a table or the like, and the top face of the receptacle (12) is held against the top of the plank (1). The razor blade (9) height is adjusted by turning the adjusting screw (6) until it is at the correct distance from the top surface of the plank (1) to facilitate removal of the retaining lip. As the trimmer (11) is pulled along the edge of the plank (1), a handle (13) aids in keeping the trimmer (11) firmly in its cutting position, resulting in a smooth removal of the retaining lip.

An added feature of one embodiment of the flooring trimmer (11) is an inspection hole (14) which allows the lower portion of the razor blade (9) to be inspected for wear. When the razor blade (9) is needing to be replaced, the retaining screw (10) is removed and a new blade is inserted in the blade housing (8).

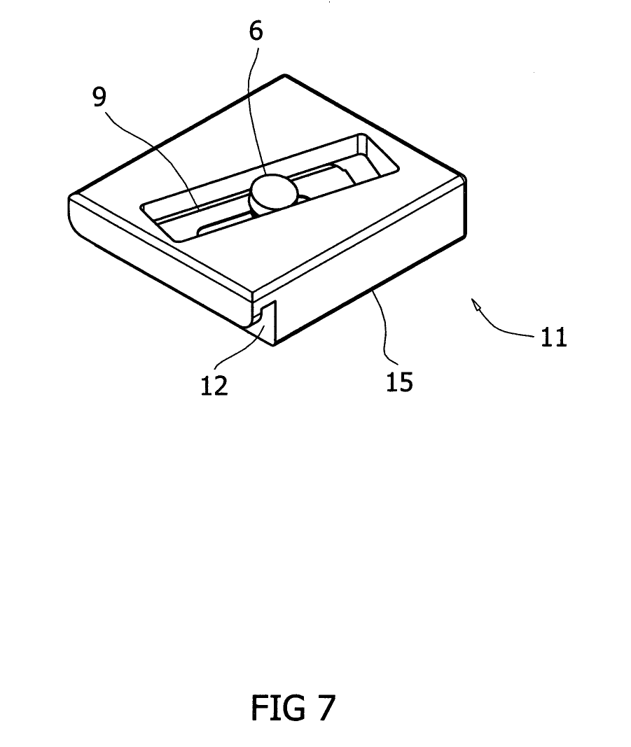

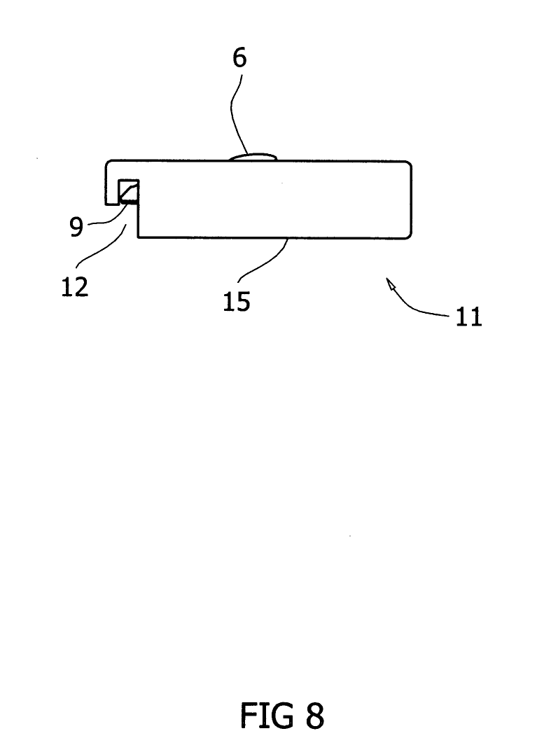

An alternate embodiment of the flooring trimmer is shown in FIG. 7 and FIG. 8. This embodiment simplifies construction by eliminating the blade adjusting components. The main housing (15) is manufactured as one piece of material. The razor blade (9) is held in place with the blade retaining screw (10) at a compound angle to the retaining lip of the floor plank (1). The razor blade (9) in FIGS. 7 and 8 is held at a fifteen degree angle to the upper surface and fifteen degree angle to the side of the flooring plank (1). Although these angles work well for removing the retaining lip from the flooring plank (1) it should not be meant to limit the scope of the claims of the flooring trimmer assembly (11).

I claim:

1. A cutting tool for laminate flooring and the like comprising:
a. a main housing having a recess to accept the edge of a flooring plank, said recess consisting of a pair of parallel walls to guide the top and bottom surfaces and locking edge of said flooring plank,
b. a pocket in the upper surface of said main housing,
c. a razor blade fastened to the bottom surface of said pocket, whereby said cutting tool facilitates removal of all or a portion of said locking edge of said flooring plank,

2. The cutting tool of claim 1 wherein said pocket in said upper surface contains an adjustable razor blade holder that is accepted into said pocket, said razor blade holder further comprising an adjustment screw for adjusting the height of said razor blade relative to said retaining lip of said flooring plank.

3. The cutting tool of claim 1 wherein said pocket is constructed at a compound angle to said edge of a flooring plank whereby said compound angle facilitates easy removal of said retaining lip of said flooring plank.

4. A cutting tool for laminate flooring and the like comprising:
a. a main housing having a recess to accept the edge of a flooring plank, said recess consisting of a vertical surface and a downwardly extending lip, whereby said downwardly extending lip is received in the recessed portion of said flooring plank,
b. a pocket in the upper surface of said main housing,
c. a razor blade fastened to the bottom surface of said pocket, the cutting edge of said razor blade being located at a fixed height relative to the lower portion of said downwardly extending lip, whereby said cutting tool facilitates removal of all or a portion of said locking edge of said flooring plank.

5. The cutting tool of claim 4 wherein said pocket is constructed at a compound angle to said edge of a flooring plank whereby said compound angle facilitates easy removal of said retaining lip of said flooring plank.
